(19) United States
(12) Patent Application Publication
(10) Pub. No.: US 2025/0159004 A1
(43) Pub. Date: May 15, 2025

(54) TECHNIQUES FOR DETERMINING DIGITAL ASSET SECURITY FROM AN EXTERNAL ATTACK SURFACE

(71) Applicant: Cycognito, Ltd., Tel Aviv (IL)

(72) Inventors: Dima POTEKHIN, Tel Aviv (IL); Amit AMAR, Tel Aviv (IL); Hed BAR-NISSAN, Tel Aviv (IL); Rob N. GURZEEV, Palo Alto, CA (US)

(73) Assignee: Cycognito, Ltd., Tel Aviv (IL)

(21) Appl. No.: 18/507,819

(22) Filed: Nov. 13, 2023

(51) Int. Cl. H04L 9/40

(52) U.S. Cl. CPC H04L 63/1416; H04L 63/1425

(57) ABSTRACT

A system and method for determining digital asset security from an external attack surface. The method includes: continuously detecting digital asset information from a networked computing environment; continuously determining a cybersecurity severity score for a digital asset based on the detected digital asset information; continuously determining an asset exposure score for the digital asset based on the detected digital asset information; continuously determining an asset importance score for the digital asset based on the detected digital asset information; generating a digital asset security score based on: the determined cybersecurity severity score, the asset exposure score, and the asset importance score.

### TECHNICAL FIELD

The present disclosure relates generally to determining security of a digital asset, and specifically to detecting an attack path to a digital asset from an external attack surface.

### BACKGROUND

An external attack surface is the number of all possible points of entry (AKA attack vectors) where an unauthorized user can access a system and extract data. Attack vectors are often publicly facing digital assets, such as infrastructure responsible for hosting customer facing websites for example.

It is advantageous for an enterprise to know the number and scope of publicly accessible digital assets on their networks in order to minimize risks stemming from potential exploitation of these assets.

In order to assess and manage risk, enterprises need to map digital assets, both public and private, to detect and remedy potential vulnerabilities before they are exploited.

It is impossible, however, to truly map and know all potential vulnerabilities in a large enterprise network without complete knowledge of all assets on the network.

Furthermore, it is nearly impossible to have complete knowledge without performing frequent network sweeps and asset cataloguing. In the current “bring your own device” era of enterprise computing, many assets are classified as “Shadow IT” or “Unknown unknowns”—assets which are not known to those within the enterprise responsible for asset management. This is before one considers the potential for a threat actor to bring their own malicious devices onto the enterprise asset network.

Finally, assets on a network are of differing levels of importance. Specifically, some assets, if compromised, would have potentially catastrophic effects on the residual network, whereas others can be safely isolated with minimal disruption. Quantifying such an assessment, however, requires the enterprise to have the aforementioned asset knowledge in a form representative of an up-to-the-minute snapshot of the entire asset network.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include continuously detecting digital asset information from a networked computing environment. Method may also include continuously determining a cybersecurity severity score for a digital asset based on the detected digital asset information. Method may furthermore include continuously determining an asset exposure score for the digital asset based on the detected digital asset information. Method may in addition include continuously determining an asset importance score for the digital asset based on the detected digital asset information. Method may moreover include generating a digital asset security score based on: the determined cybersecurity severity score, the asset exposure score, and the asset importance score. Other embodiments of this aspect include corresponding computer systems, apparatus, and computer programs recorded on one or more computer storage devices, each configured to perform the actions of the methods.

Implementations may include one or more of the following features. Method may include: continuously determining an attacker attractiveness score for the digital asset based on the detected digital asset information; and generating the digital asset security score further based on: the determined attacker attractiveness score. Method may include: initiating a mitigation action based on a value of the digital asset security score. Method may include: generating the digital asset security score further based on: a determined cybersecurity severity score of a second digital asset, a second asset exposure score of the second digital asset, and a second asset importance score of the second digital asset. Method may include: detecting an attack path from the external attack surface to the digital asset; and determining the asset exposure score further based on the detected attack path. Method may include: detecting on the digital asset any one of: a vulnerability, an exposure, and a combination thereof; and determining the cybersecurity severity score further based on the detected: vulnerability, exposure, and the combination thereof. Method may include: sending a network protocol message to the digital asset; receiving a reply to the network protocol message; and determining the asset exposure score further based on the received reply. Method where the reply includes any one of: a programmatic representation of a web page, an error message, an HTTP response, a data packet, an internal document, sensitive data, and a combination thereof. Method may include: performing deep inspection on a received content; and determining a type of content based on the deep inspection. Method may include: parsing the reply to detect a data field value; and determining a score further based on the detected data field value. Method may include: detecting in the reply to the network protocol message a content. Method where the content includes: personal identifiable information, an email server identification, a sensitive data indicator, and any combination thereof. Implementations of the described techniques may include hardware, a method or process, or a computer tangible medium.

In one general aspect, non-transitory computer-readable medium may include one or more instructions that, when executed by one or more processors of a device, cause the device to: Non-transitory computer-readable medium may also include continuously detect digital asset information from a networked computing environment. Medium may furthermore include continuously determine a cybersecurity severity score for a digital asset based on the detected digital asset information. Medium may in addition include continuously determine an asset exposure score for the digital asset based on the detected digital asset information. Medium may moreover include continuously determine an asset importance score for the digital asset based on the detected digital asset information. Medium may also include generate a digital asset security score based on: the determined cybersecurity severity score, the asset exposure score, and the asset importance score. Other embodiments of this aspect include corresponding computer systems, apparatus, and computer programs recorded on one or more computer storage devices, each configured to perform the actions of the methods.

In one general aspect, system may include a processing circuitry. System may also include a memory, the memory containing instructions that, when executed by the processing circuitry, configure the system to: continuously detect digital asset information from a networked computing environment. System may in addition continuously determine a cybersecurity severity score for a digital asset based on the detected digital asset information. System may moreover continuously determine an asset exposure score for the digital asset based on the detected digital asset information. System may also continuously determine an asset importance score for the digital asset based on the detected digital asset information. System may furthermore generate a digital asset security score based on: the determined cybersecurity severity score, the asset exposure score, and the asset importance score. Other embodiments of this aspect include corresponding computer systems, apparatus, and computer programs recorded on one or more computer storage devices, each configured to perform the actions of the methods.

Implementations may include one or more of the following features. System where the memory contains further instructions which when executed by the processing circuitry further configure the system to: continuously determine an attacker attractiveness score for the digital asset based on the detected digital asset information; and generate the digital asset security score further based on: the determined attacker attractiveness score. System where the memory contains further instructions which when executed by the processing circuitry further configure the system to: initiate a mitigation action based on a value of the digital asset security score. System where the memory contains further instructions which when executed by the processing circuitry further configure the system to: generate the digital asset security score further based on: a determined cybersecurity severity score of a second digital asset, a second asset exposure score of the second digital asset, and a second asset importance score of the second digital asset. System where the memory contains further instructions which when executed by the processing circuitry further configure the system to: detect an attack path from the external attack surface to the digital asset; and determine the asset exposure score further based on the detected attack path. System where the memory contains further instructions which when executed by the processing circuitry further configure the system to: detect on the digital asset any one of: a vulnerability, an exposure, and a combination thereof; and determine the cybersecurity severity score further based on the detected: vulnerability, exposure, and the combination thereof. System where the memory contains further instructions which when executed by the processing circuitry further configure the system to: send a network protocol message to the digital asset; receive a reply to the network protocol message; and determine the asset exposure score further based on the received reply. System where the reply includes any one of: a programmatic representation of a web page, an error message, an HTTP response, a data packet, an internal document, sensitive data, and a combination thereof. System where the memory contains further instructions which when executed by the processing circuitry further configure the system to: perform deep inspection on a received content; and determine a type of content based on the deep inspection. System where the memory contains further instructions which when executed by the processing circuitry further configure the system to: parse the reply to detect a data field value; and determine a score further based on the detected data field value. System where the memory contains further instructions which when executed by the processing circuitry further configure the system to: detect in the reply to the network protocol message a content. System where the content includes: personal identifiable information, an email server identification, a sensitive data indicator, and any combination thereof. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic illustration of a digital asset detector for detecting digital assets of a computing environment, utilized to describe an embodiment.

FIG. 2 is an example flowchart of a method for detecting digital asset information within a networked computing environment and generating an asset security score, implemented in accordance with an embodiment.

FIG. 3 is an example schematic diagram of a digital asset detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for determining digital asset security from an external attack surface is disclosed. According to an embodiment, a computing environment is scanned through its external attack surface to detect persistent digital assets. In an embodiment, a digital asset detector is configured to detect digital assets, and determine a security score. In some embodiments, the security score is based on a severity score, an asset exposure score, an asset importance score, an attacker attractiveness score, a combination thereof, and the like.

It is recognized in this regard, that a human is capable of scoring a digital asset. However, a human applies subjective criteria when scoring, which results in an inconsistent scoring method across assets. As a digital environment includes often hundreds, thousands, or more of digital assets, it would be impossible for a human to apply consistently objective criteria to scoring an asset.

Furthermore, digital assets change over time. IP addresses can change, domain names, sub domain names, software versions, software packages, and so on, are all subject to change over time. A human is incapable of making an objective determination if information related to an asset describes an already existing asset or a new asset.

The system disclosed herein solves at least these issues by applying predetermined criteria in an objective manner both in detection of digital assets, and in application of scoring criteria to determine a security score in a cybersecurity context.

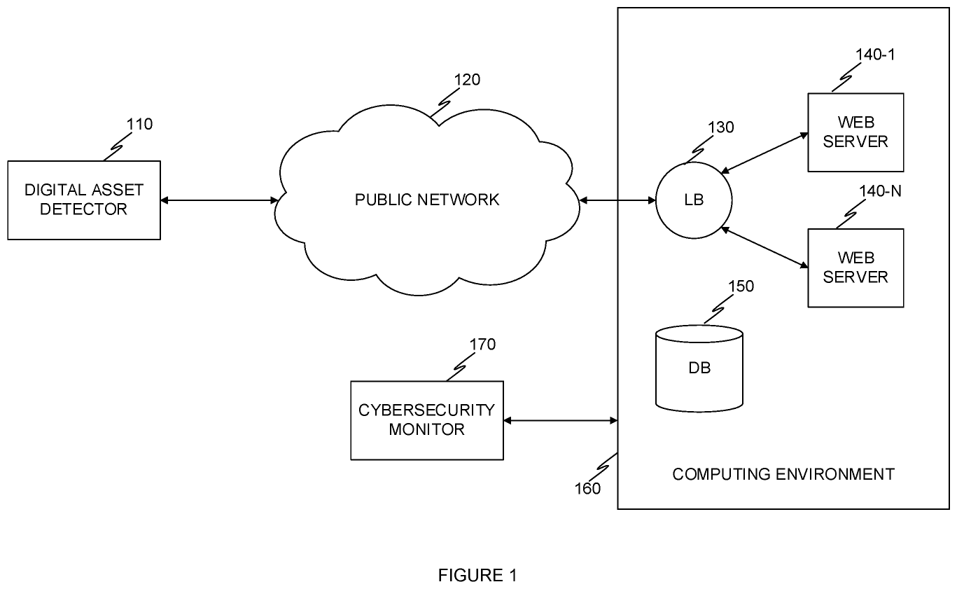

FIG. 1 is an example schematic illustration of a digital asset detector for detecting digital assets of a computing environment, utilized to describe an embodiment. In an embodiment, a digital asset detector 110 is configured to detect digital assets, for example over a public network 120, of a computing environment 160. According to an embodiment, a cybersecurity monitor 170 is configured to detect cybersecurity threats in the computing environment 160.

In an embodiment, a computing environment 160 includes a load balancer 130, a plurality of web servers 140-1 through 140-N, where “N” is an integer having a value of “2” or greater, generally referred to as web servers 140 and individually as web server 140. In some embodiments, the computing environment 160 further includes a database 150, a resource, a principal, various combinations thereof, and the like.

According to an embodiment, a computing environment 160 includes a collection of digital assets, such as web server 140-1 and database 150, with such assets being accessible through, for example, the load balancer 130, via the public network 120.

In an embodiment, a computing environment 160 is implemented as a cloud computing environment, such as a virtual private cloud (VPC), a virtual network (VNet), a combination thereof, and the like. In certain embodiments, a cloud computing environment is implemented on a cloud computing infrastructure, such as Amazon® Web Services (AWS), Microsoft® Azure, Google® Cloud Platform (GCP), a combination thereof, and the like.

In an embodiment, a database 150 is implemented as a relational database, a graph database, a document database, a graph database, and the like. In certain embodiments, the database 150 is a cloud-based database, for example Amazon® RDS, Microsoft® Azure DB, and the like, an “on-premises” database, and the like.

For example, according to an embodiment, a web server 140-1 includes a web application through which a purchase can be made, e.g., an ecommerce platform. In an embodiment, each transaction performed on the web application is recorded as a database transaction in the database 150. In an embodiment, the database 150 stores personally identifiable information (PII), payment card industry (PCI) information, personal health information (PHI), a combination thereof, and the like.

According to an embodiment, a digital asset detector 110 is configured to detect digital assets exposed on a public network 120. In an embodiment, the digital asset detector 110 is configured to continuously detect digital assets through continuous scanning of the public network 120.

In an embodiment, detected assets, and pathways discovered between the detected assets are detected by the digital asset detector 110. For example, in an embodiment, a pathway is discovered between the load balancer 130 and a web server 140. In some embodiments, a representation of a digital asset, a network path (e.g., pathway) between digital assets, and the like, are catalogued by the digital asset detector 110 and stored on a database of detected digital assets. In an embodiment, the digital asset detector 110 is configured to update asset information stored in a database, for example based on newly detected information.

According to an embodiment, a public network 120 includes network components such as: load balancers, web servers, API endpoints, virtual machines, databases, firewalls, and the like. In an embodiment, a public network 120 is available to all individuals able to connect to the network, with no requirement to authenticate or authorize themselves prior to establishing a connection, such as, for example, the Internet. In some embodiments, components on a public network 120 are visible to anyone able to browse the network.

In an embodiment, an external attack surface is realized as a collection of digital assets visible, accessible, and the like, on the public network 120. For example, according to an embodiment, a load balancer 130, is a digital asset in an external attack surface of the computing environment 160.

In an embodiment, a load balancer 130 is a networked digital asset configured to receive a connection request to another digital asset, resource, and the like, for example hosted on a web server 140, and redirecting the request to a web server 140 based on a load balancing scheme. For example, according to an embodiment, a load balancer 130 is configured to utilize a round-robin load balancing mechanism. A load balancer 130 is configured to direct traffic based on one or more rules, policies, trigger events, and the like, according to an embodiment.

In an embodiment, the load balancer 130 is visible within a public network 120, to anyone (i.e., any user account) able to access visible assets on the network. Because of this visibility, a load balancer 130 serves as an entry-point to a computing environment 160 and any assets, for example web servers 140, which the load balancer is configured to direct traffic to.

In an embodiment, a web server 140 is a networked asset included within a computing environment 160 and is accessed directly, e.g., as part of the public network 120, indirectly, e.g., through having connections routed to it from a load balancer 130, and the like. In an embodiment, a web server 140-1 is a single asset within a plurality of assets, including web server 140-N, a database 150, and the like.

According to an embodiment, web servers 140-1 through 140-N are connected to each other within a computing environment 160, thereby constituting an attack path. Through an attack path, an attacker can gain access from one resource to another.

In an embodiment, a cybersecurity monitoring system 170 is configured to monitor a computing environment 160 for cybersecurity threats, such as misconfigurations, vulnerabilities, exposures, and the like.

According to an embodiment, the cybersecurity monitoring system 170 is configured to generate an asset score for each digital asset based upon properties of detected digital assets, such as their exposure to other assets within a computing environment 160, a software application detected thereon, a version of an operating system, a version of processor, a combination thereof, and the like.

For example, according to an embodiment, a cybersecurity monitoring system 170 is configured to detect a cybersecurity threat on a digital asset, such as an outdated software version. In an embodiment, the cybersecurity monitoring system 170 is further configured to generate a cybersecurity severity score based on information collected about a digital asset deployed in the computing environment 160.

In some embodiments, the digital asset detector 110 is configured to determine an asset exposure score. For example, in an embodiment, an asset exposure score is determined based on a number of resources that each need to be accessed prior to accessing the digital asset (e.g., accessing a load balancer prior to accessing a web server).

In certain embodiments, an asset importance score is determined. In an embodiment, the asset importance score is determined by the digital asset detector 110. For example, according to an embodiment, an asset importance score is determined based on detecting an indicator value, a software application type, a database type, a metadata, a combination thereof, and the like. For example, in an embodiment, a database of a first type has a higher asset importance score than a database of a second type. This is useful, for example, where certain databases types are utilized in storing sensitive information.

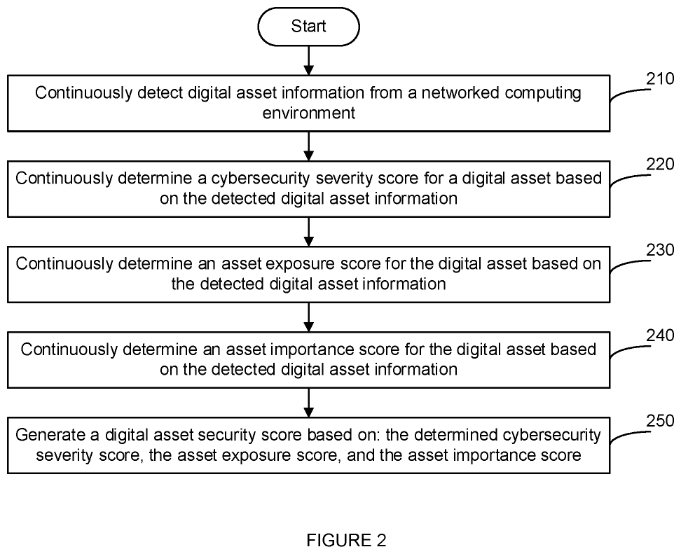

In some embodiments, an attacker attractiveness score is determined. According to an embodiment, an attacker attractiveness score is determined based on how attractive an asset is for an attacker. In some embodiments, this is different than an asset importance score. For example, in an embodiment, an asset that is attractive to an attacker is not an asset that is important to an asset owner. In this example, an attacker finds two databases equally important, however only one of these databases includes personally identifiable information (PII), thus the database with PII is a digital asset which is more important to the asset owner, and therefore has a higher asset importance score. FIG. 2 is an example flowchart of a method for detecting digital asset information within

a networked computing environment and generating an asset security score, implemented in accordance with an embodiment.

At S210, digital asset information is detected. In an embodiment, a digital asset detector is configured to continuously detect digital assets within a networked computing environment and storing or updating their information within a digital asset database.

In an embodiment, digital assets are detected by a digital asset detector, starting with those assets exposed on a public network. In certain embodiments, the digital asset detector is configured to discover additional assets reachable from a publicly exposed asset. In some embodiments, the digital asset detector is further configured to generate an attack path including an exposed asset, and an asset connected to the exposed asset (e.g., a load balancer and a web server).

In some embodiments, digital asset information, including pathways between assets, is stored in a known asset information database.

According to an embodiment, the digital asset detector is configured to continuously scan the asset network, a public network, and the like, for changes to the network, including the addition and removal of assets, new connections between assets, a combination thereof, and the like. In an embodiment, in response to detecting a change in asset information, a new asset score is determined. For example, in an embodiment, a new asset score is updated in indication of a cybersecurity risk.

At S220, a cybersecurity severity score for a digital asset is determined. In some embodiments, the cybersecurity severity score is continuously generated and updated based on the detected digital asset's information. In an embodiment, a cybersecurity monitor is configured to continuously monitor a known asset for changes to digital asset information, cybersecurity risks, and the like.

In certain embodiments, a cybersecurity monitoring system is configured to determine a cybersecurity severity score for each digital asset based on: the detected digital asset information, the detected digital asset's identified vulnerabilities, the detected digital asset's exposure to other digital assets, a combination thereof, and the like.

At S230, an asset exposure score for a digital asset is determined. In an embodiment, an asset exposure score is continuously updated based on the detected digital asset's information. In an embodiment, a cybersecurity monitor is configured to continuously monitor a database of known assets for changes to digital asset information. According to an embodiment, an asset exposure score is determined based on: the detected digital asset's visibility on the public network, the detected asset's connectedness to other assets, a combination thereof, and the like.

At S240, an asset importance score for a digital asset is determined. In an embodiment, the asset importance score is continuously determined and updated based on the detected digital asset's information. In some embodiments, an asset importance score is determined based on: a type of the digital asset, a data accessible through the asset (e.g., as determined through deep packet inspection), a network protocol message reply from the asset, a network protocol message response, a combination thereof, and the like.

In some embodiments, an attacker attractiveness score is determined. According to an embodiment, an attacker attractiveness score is determined based on how attractive an asset is for an attacker. In some embodiments, this is different than an asset importance score. For example, in an embodiment, an asset that is attractive to an attacker is not an asset that is important to an asset owner. In this example, an attacker finds two databases equally important, however only one of these databases includes personally identifiable information (PII), thus the database with PII is a digital asset which is more important to the asset owner, and therefore has a higher asset importance score.

As another example, an attacker attractiveness score is further determined based on detecting PII, a database, a mail server, an ecommerce platform, a combination thereof, and the like.

At S250, a digital asset security score is determined. In some embodiments, the security score is generated and continuously updated for a detected digital asset. According to an embodiment, the digital asset security score is based on: the determined cybersecurity severity score of the asset, the asset exposure score of the asset, and the asset importance score of the asset.

In certain embodiments, the security score is updated in response to detecting that a value of the aggregate compositional scores (e.g., the asset importance score, asset exposure score, cybersecurity severity score, and combination thereof) changes. In some embodiments, the aggregate compositional scores change periodically as new digital assets are detected by a digital asset detector, as new information is detected by a digital asset detector of existing digital assets, combinations thereof, and the like.

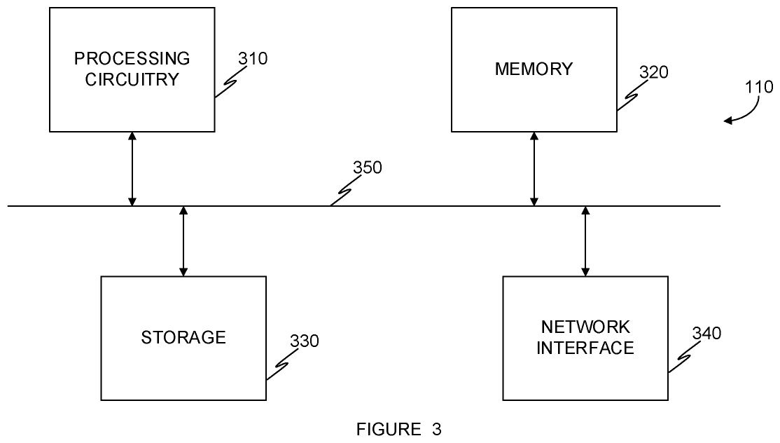

FIG. 3 is an example schematic diagram of a digital asset detector 110 according to an embodiment. The digital asset detector 110 includes a processing circuitry 310 coupled to a memory 320, a storage 330, and a network interface 340. In an embodiment, the components of the digital asset detector 110 may be communicatively connected via a bus 350.

The processing circuitry 310 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 320 may be volatile (e.g., random access memory, etc.), non-volatile (e.g., read only memory, flash memory, etc.), or a combination thereof. In an embodiment, the memory 320 is an on-chip memory, an off-chip memory, a combination thereof, and the like. In certain embodiments, the memory 320 is a scratch-pad memory for the processing circuitry 310.

In one configuration, software for implementing one or more embodiments disclosed herein may be stored in the storage 330, in the memory 320, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 310, cause the processing circuitry 310 to perform the various processes described herein.

The storage 330 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 340 is configured to provide the digital asset detector 110 with communication with, for example, the public network 120, the computing environment 160, the cybersecurity monitoring system 170, and the like.

It should be understood that the embodiments described herein are not limited to the specific architecture illustrated in FIG. 3, and other architectures may be equally used without departing from the scope of the disclosed embodiments.

Furthermore, in certain embodiments the cybersecurity monitoring system 170 may be implemented with the architecture illustrated in FIG. 3. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for determining digital asset security from an external attack surface, comprising:
continuously detecting digital asset information from a networked computing environment;
continuously determining a cybersecurity severity score for a digital asset based on the detected digital asset information;
continuously determining an asset exposure score for the digital asset based on the detected digital asset information;
continuously determining an asset importance score for the digital asset based on the detected digital asset information;
generating a digital asset security score based on: the determined cybersecurity severity score, the asset exposure score, and the asset importance score.

2. The method of claim 1, further comprising:
continuously determining an attacker attractiveness score for the digital asset based on the detected digital asset information; and
generating the digital asset security score further based on: the determined attacker attractiveness score.

3. The method of claim 2, further comprising:
initiating a mitigation action based on a value of the digital asset security score.

4. The method of claim 2, further comprising:
generating the digital asset security score further based on: a determined cybersecurity severity score of a second digital asset, a second asset exposure score of the second digital asset, and a second asset importance score of the second digital asset.

5. The method of claim 2, further comprising:
detecting an attack path from the external attack surface to the digital asset; and
determining the asset exposure score further based on the detected attack path.

6. The method of claim 2, further comprising:
detecting on the digital asset any one of: a vulnerability, an exposure, and a combination thereof; and
determining the cybersecurity severity score further based on the detected: vulnerability, exposure, and the combination thereof.

7. The method of claim 2, further comprising:
sending a network protocol message to the digital asset;
receiving a reply to the network protocol message; and
determining the asset exposure score further based on the received reply.

8. The method of claim 7, wherein the reply includes any one of: a programmatic representation of a web page, an error message, an HTTP response, a data packet, an internal document, sensitive data, and a combination thereof.

9. The method of claim 7, further comprising:
performing deep inspection on a received content; and
determining a type of content based on the deep inspection.

10. The method of claim 7, further comprising:
parsing the reply to detect a data field value; and
determining a score further based on the detected data field value.

11. The method of claim 7, further comprising:
detecting in the reply to the network protocol message a content.

12. The method of claim 11, wherein the content includes: personal identifiable information, an email server identification, a sensitive data indicator, and any combination thereof.

13. A non-transitory computer-readable medium storing a set of instructions for determining digital asset security from an external attack surface, the set of instructions comprising:
one or more instructions that, when executed by one or more processors of a device, cause the device to:
continuously detect digital asset information from a networked computing environment;
continuously determine a cybersecurity severity score for a digital asset based on the detected digital asset information;
continuously determine an asset exposure score for the digital asset based on the detected digital asset information;
continuously determine an asset importance score for the digital asset based on the detected digital asset information;
generate a digital asset security score based on: the determined cybersecurity severity score, the asset exposure score, and the asset importance score.

14. A system for determining digital asset security from an external attack surface comprising:
a processing circuitry;
a memory, the memory containing instructions that, when executed by the processing circuitry, configure the system to:
continuously detect digital asset information from a networked computing environment;
continuously determine a cybersecurity severity score for a digital asset based on the detected digital asset information;
continuously determine an asset exposure score for the digital asset based on the detected digital asset information;
continuously determine an asset importance score for the digital asset based on the detected digital asset information;
generate a digital asset security score based on: the determined cybersecurity severity score, the asset exposure score, and the asset importance score.

15. The system of claim 14, wherein the memory contains further instructions which when executed by the processing circuitry further configure the system to:
continuously determine an attacker attractiveness score for the digital asset based on the detected digital asset information; and
generate the digital asset security score further based on: the determined attacker attractiveness score.

16. The system of claim 15, wherein the memory contains further instructions which when executed by the processing circuitry further configure the system to:
initiate a mitigation action based on a value of the digital asset security score.

17. The system of claim 15, wherein the memory contains further instructions which when executed by the processing circuitry further configure the system to:
generate the digital asset security score further based on: a determined cybersecurity severity score of a second digital asset, a second asset exposure score of the second digital asset, and a second asset importance score of the second digital asset.

18. The system of claim 15, wherein the memory contains further instructions which when executed by the processing circuitry further configure the system to:
detect an attack path from the external attack surface to the digital asset; and
determine the asset exposure score further based on the detected attack path.

19. The system of claim 15, wherein the memory contains further instructions which when executed by the processing circuitry further configure the system to:
detect on the digital asset any one of: a vulnerability, an exposure, and a combination thereof; and
determine the cybersecurity severity score further based on the detected: vulnerability, exposure, and the combination thereof.

20. The system of claim 15, wherein the memory contains further instructions which when executed by the processing circuitry further configure the system to:
send a network protocol message to the digital asset;
receive a reply to the network protocol message; and
determine the asset exposure score further based on the received reply.

21. The system of claim 20, wherein the reply includes any one of:
a programmatic representation of a web page, an error message, an HTTP response, a data packet, an internal document, sensitive data, and a combination thereof.

22. The system of claim 20, wherein the memory contains further instructions which when executed by the processing circuitry further configure the system to:
perform deep inspection on a received content; and
determine a type of content based on the deep inspection.

23. The system of claim 20, wherein the memory contains further instructions which when executed by the processing circuitry further configure the system to:
parse the reply to detect a data field value; and
determine a score further based on the detected data field value.

24. The system of claim 20, wherein the memory contains further instructions which when executed by the processing circuitry further configure the system to:
detect in the reply to the network protocol message a content.

25. The system of claim 24, wherein the content includes:
personal identifiable information, an email server identification, a sensitive data indicator, and any combination thereof.
